(19) United States
(12) Patent Application Publication
(10) Pub. No.: US 2012/0262585 A1
(43) Pub. Date: Oct. 18, 2012

(54) RECORDING CONTROL DEVICE, INFORMATION DEVICE, INFORMATION RECORDING SYSTEM AND PROGRAM

(75) Inventor: Hironori NAKANO, Osaka (JP)

(73) Assignee: PANASONIC CORPORATION, Osaka (JP)

(21) Appl. No.: 13/444,978

(22) Filed: Apr. 12, 2012

(30) Foreign Application Priority Data
Apr. 14, 2011 (JP) 2011-089886

(51) Int. Cl. H04N 5/225

(52) U.S. Cl. 348/207.1; 348/E05.024

(57) ABSTRACT

A recording control device is capable of transmitting and receiving information to and from an external information device. The recording control device includes a first storage medium; and a control section for, when acquiring the information from the external information device, storing the information on the first storage medium, and when connection with the external information device is disconnected, recording the information stored on the first storage medium, or other information based on the information stored on the first storage medium, on a second storage medium.

### BACKGROUND OF THE INVENTION

1. Field of the Invention

The present invention relates to a technology for controlling recording of information transmitted from an information device.

2. Description of the Related Art

Technologies for transmitting and receiving information by connecting an external information device such as a personal computer or the like and a recording control device such as a movie camera or the like via USB connection or the like are known. For example, Japanese Laid-Open Patent Publication No. 2010-232977 discloses a technology by which a personal computer acquires a control code stored on a video camera regularly or irregularly and transmits video data stored on the personal computer to the video camera in accordance with the control code.

Information recorded on a recording control device such as a movie camera or the like, for example, moving image data or still image data, is often important information for a user. Therefore, a serious problem occurs if, while the recording control device is connected to an external information device such as a personal computer or the like by USB connection or the like, the information recorded on the recording control device is inadvertently deleted or falsified by the external information device. In order to avoid a risk of such inadvertent deletion or falsification, information write by the external information device is usually prohibited while the recording control device is connected to the external information device.

However, in the case where information write by the external information device is prohibited, information carried by the external information device cannot be recorded on the recording control device when necessary.

In light of such a problem, an embodiment of the present invention provides a recording control technology capable of recording information carried by an external information device or other information based on such information at an appropriate timing.

### SUMMARY OF THE INVENTION

A recording control device according to an embodiment of the present invention is structured to be connectable with an external information device and capable of transmitting and receiving information via the connection. The recording control device includes a first storage medium; and a control section configured to, when acquiring the information from the external information device, store the information on the first storage medium, and when the connection with the external information device is disconnected, record the information stored on the first storage medium, or other information based on the information stored on the first storage medium, on a second storage medium.

In an embodiment, the recording control device further includes a connector for connecting the recording control device to the external information device via a cable. When the cable is pulled out after the control section stores the information on the first storage medium, the control section records the information stored on the first storage medium, or other information based on the information stored on the first storage medium, on the second storage medium.

In an embodiment, the control section, after transmitting data to the external information device, acquires a notice regarding processing of the data from the external information device as the information.

In an embodiment, the external information device, when acquiring the data from the control section, uploads the data to another device via a network; and the control section acquires a notice regarding the upload of the data from the external information device as the information.

In an embodiment, the external information device, when acquiring the data from the recording control device, stores the data on the second storage medium as a backup; and the control section acquires a notice regarding the backup of the data from the external information device as the information.

In an embodiment, the control section transmits the data to the external information device based on instruction information recorded on the second storage medium, and when receiving a notice indicating whether the processing of the data has been completed or not from the external information device, updates the instruction information.

In an embodiment, the instruction information is information indicating data which is set by a user as a target of transmission.

In an embodiment, the data includes data on a moving image.

In an embodiment, the recording control device further includes an imaging section for acquiring the moving image by shooting.

An information device according to an embodiment of the present invention is structured to process data transmitted from any one type of recording control device described above. The information device includes a processor configured to execute the steps of sensing that connection with the recording control section has been established; reading instruction information that defines data to be processed from a second storage medium when the connection is established; processing the data based on the instruction information if there is the instruction information; and transmitting information indicating whether the processing of the data has been completed or not to the information device.

An information recording system according to an embodiment of the present invention includes: an information device; and a recording control device connectable with the information device and capable of transmitting and receiving information via the connection. The recording control device includes a first storage medium; and a control section configured to, when acquiring the information from the information device, store the information on the first storage medium, and when the connection with the information device is disconnected, record the information stored on the first storage medium, or other information based on the information stored on the first storage medium, on a second storage medium.

A computer program according to an embodiment of the present invention is stored on a non-transitory computer-readable medium, to be executed by a computer mounted in a recording control device connectable with an external information device and capable of transmitting and receiving information via the connection. The program causes a computer to execute the steps of acquiring information from the external information device; storing the information on a first storage medium; and sensing that the connection with the external information device has been disconnected and recording the information stored on the first storage medium, or other information based on the information stored on the first storage medium, on a second storage medium.

A computer program according to an embodiment of the present invention is stored on a non-transitory computer-readable medium, to be executed by a computer mounted in an information device configured to process data transmitted from any one type of recording control device described above. The program causes a computer to execute the steps of: sensing that connection with the recording control device has been established; reading instruction information which defines data to be processed from the second storage medium when the connection is established; processing the data based on the instruction information if there is the instruction information; and transmitting information indicating whether the processing of the data has been completed or not to the information device.

According to an embodiment of the present invention, information carried by an external information device can be recorded at an appropriate timing.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1A is a block diagram showing a basic structure in an embodiment according to the present invention.

FIG. 1B is a flowchart showing an operation of a recording control device in an embodiment.

FIG. 1C is a flowchart showing an operation of an information device in an embodiment.

FIG. 2 is a system configuration diagram in Embodiment 1.

FIG. 3 shows an example of upload instruction information in Embodiment 1.

FIG. 4 is a flowchart showing a processing operation of a personal computer in Embodiment 1.

FIG. 5 is a flowchart showing a processing operation of a movie camera in Embodiment 1.

FIG. 6 shows an example of upload completion information in Embodiment 1.

FIG. 7 shows an example of post-update upload completion information in Embodiment 1.

### DETAILED DESCRIPTION OF PREFERRED EMBODIMENTS

Before describing a specific embodiment according to the present invention, an outline of a basic structure and operation in an embodiment according to the present invention will be described.

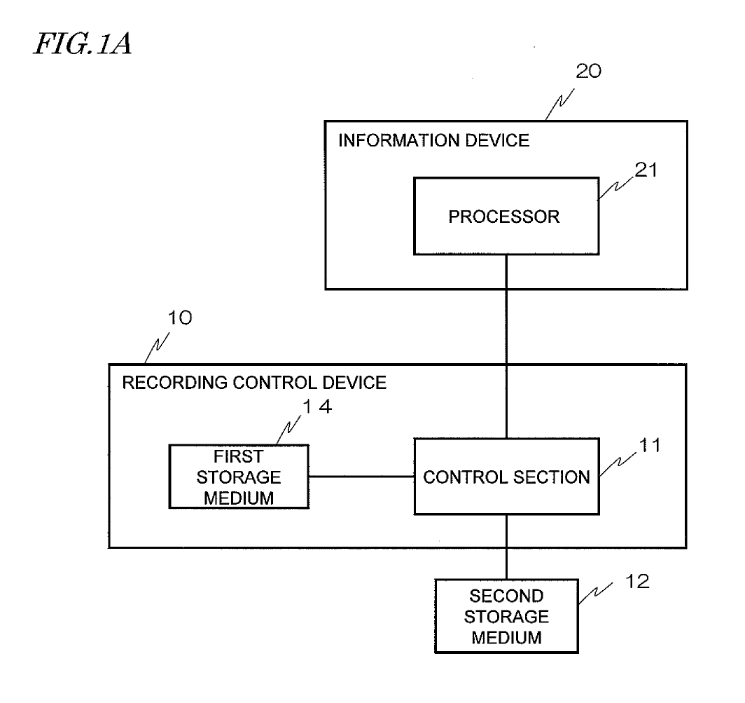

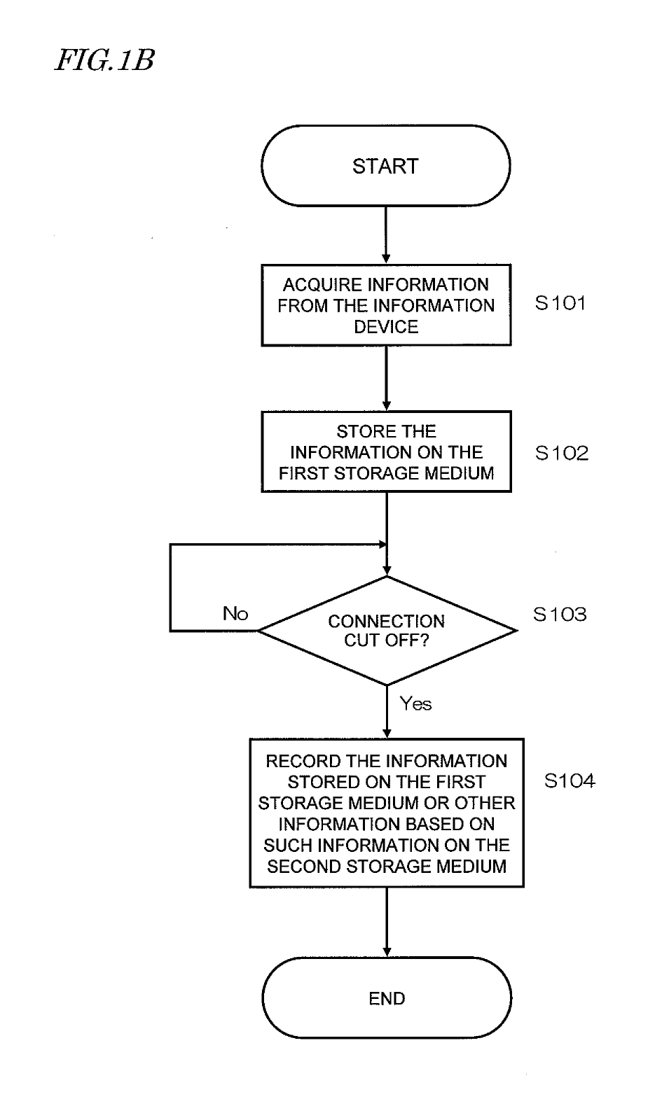

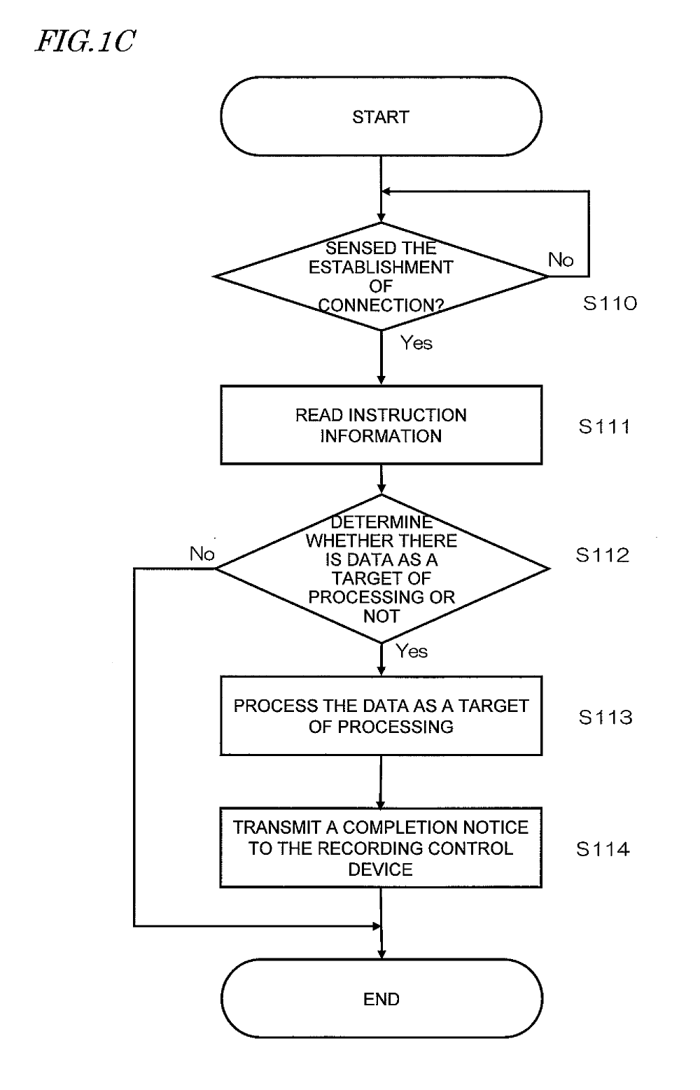

FIG. 1A is a block diagram showing a basic structure of an information recording system according to an embodiment of the present invention. The information recording system includes a recording control device 10 for controlling recording of information, and an external information device 20 connected to the recording control device 10. The recording control device 10 and the information device 20 are connected to each other in a wired or wireless manner, and can transmit and receive information to and from each other.

The information device 20 includes a processor 21 for controlling transmission and receiving of information to and from the recording control device 10. The information device 20 may include elements other than the processor 21, but such elements are omitted in FIG. 1A for the sake of simplicity. The information device 20 may be, for example, a personal computer (PC), a mobile information terminal or a work station. The processor 21 is, for example, a central processing unit (CPU), and can execute various types of communication control or recording control by executing a control program recorded on a memory (not shown). Alternatively, the processor 21 may include dedicated hardware structured to execute various types of control.

The recording control device 10 includes a first storage medium 14 and a control section 11 for controlling recording on a second storage medium 12. The control section 11 is electrically connected to the first storage medium 14 and the second storage medium 12. The second storage medium may be built in the recording control device 10 or connected to the recording control device 10 via a cable or the like. The recording control device 10 may be a device which utilizes information recorded on the second storage medium 12, for example, a digital camera, a digital movie camera, a mobile audio player or a mobile information terminal. The recording control device 10 may actually include elements other than the elements shown in FIG. 1A, but such elements are omitted for the sake of simplicity.

The control section 11 is, for example, a central processing unit (CPU), and can execute various types of communication control or recording control by executing a control program. Alternatively, the processor 21 may be dedicated hardware structured in advance to execute various types of control. The first storage medium 14 is typically a semiconductor memory, but may be any other type of storage medium. The first storage medium 14 temporarily stores various types of data generated when the control section 11 executes processing. The second storage medium 12 may be any type of storage medium capable of storing information, and may be, for example, a memory card, an optical disc or a hard disc (HD).

Hereinafter, a basic operation in this embodiment according to the present invention will be described.

FIG. 1B is a flowchart showing a basic operation made by the control section 11 in the recording control device 10. In the state where the recording control device 10 and the information device 20 are connected to each other in a wired or wireless manner and thus information can be transmitted and received between these devices, the recording control device 10 acquires information from the information device 20 (S101). When this occurs, the control section 11 first stores the information on the first storage medium 14 (S102). When, in this state, detecting that the connection between the recording control device 10 and the information device 20 is disconnected (S103), the control section 11 records the information stored on the first recording medium or other information based on such information on the second storage medium 12 (S104). Herein, “when the connection is disconnected” encompasses when a cable connecting the recording control device 10 and the information device 20 is pulled out, and also when the communication between these devices is logically disconnected. As can be seen from this, in this specification, the term “connection” represents a concept encompassing physical connection and also logical connection.

The information transmitted from the information device 20 to the recording control device 10 may be any type of data stored on the information device 20, for example, image data, audio data, or text data. In the case where the information device 20 is structured to process data transmitted from the recording control device 10, the information transmitted from the information device 20 to the recording control device 10 may be a notice regarding the processing of such data. For example, as in an embodiment described later, the information device 20 may have a function of uploading data received from the recording control device 10 to an external server via a network such as the Internet or the like, or a function of storing such data on a storage medium such as a hard disc (HD), an optical disc or the like as a backup.

Hereinafter, an example of control in such a form will be described. In this example, the information device 20 is assumed to receive data to be uploaded or stored as a backup from the recording control device 10 and execute processing of uploading the data or storing the data as a backup. As a precondition, it is assumed that the data which is a target of transmission from the recording control device 10 to the information device 20 is defined by instruction information recorded on the second storage medium 12. The instruction information is created by, for example, a user selecting the data as a target of transmission.

FIG. 1C is a flowchart showing an operation of the processor 21 in the information device 20 in this example. The processor 21 first senses that the connection with the recording control device 10 has been established (S110). Upon sensing that the connection has been established, the processor 21 reads the instruction information recorded on the second storage medium 12 (S111). By referring to the instruction information, the processor 21 determines whether or not there is data which is a target of processing (S112). Next, the processor 21 reads the data as a target of processing from the second storage medium 12 and processes the data (S113). When the processing is completed, the processor 21 transmits a notice indicating that the processing has been completed to the recording control device 10 (S114). Alternatively, the processor 21 may transmit data on which the processing has not been completed or a notice indicating that processing has failed.

Upon receipt of the notice regarding the processing from the information device 20, the recording control device executes a recording operation based on the notice in accordance with the flow shown in FIG. 1B. When, for example, recognizing by the notice that processing on only a part of the transmitted data has been completed, the recording control device 10 can operate to record, on the second storage medium 12, new instruction information obtained as a result of excluding the data on which the processing has been completed from the target of transmission. Owing to this, the instruction information is updated, and data which does not need to be transmitted is excluded from the target of transmission.

As described above, in an embodiment according to the present invention, in the state where the recording control device 10 can communicate with the external information device 20, the recording control device 10 does not directly record information on the second storage medium and first stores the information on the first storage medium 14. After this, when the communication becomes impossible, the recording control device 10 can immediately record the information on the second storage medium 12. Owing to this control, information which needs to be recorded can be recorded on the second storage medium 12 with no delay when the communication is disconnected. This can provide splendid performance which is not realized conventionally.

If the recording on the second storage medium 12 is made possible in the state where the communication with the information device 20 is established, there is a risk that the important data recorded on the second storage medium 12 is inadvertently deleted or falsified. Therefore, recording on the second storage medium 12 by the information device 20 is usually prohibited while the communication is maintained. However, with such an arrangement, information from the information device 20 cannot be recorded when necessary, which causes a problem in terms of convenience. Hence, in an embodiment according to the present invention, the control section 11 first stores the information transmitted from the information device 20 on the first storage medium 14. At the timing when it is confirmed that the communication has been disconnected, the control section 11 records the information or other information based on such information on the second storage medium 12. Owing to such control, even if write on the second storage medium 12 during communication is set to be prohibited, the recording control device 10 can execute necessary recording processing immediately after the communication is disconnected, based on the information transmitted from the information device 20. The present invention is also applicable to a case where write on the second storage medium 12 is not prohibited while the communication is maintained.

Hereinafter, more specific embodiments of the present invention will be described.

### Embodiment 1

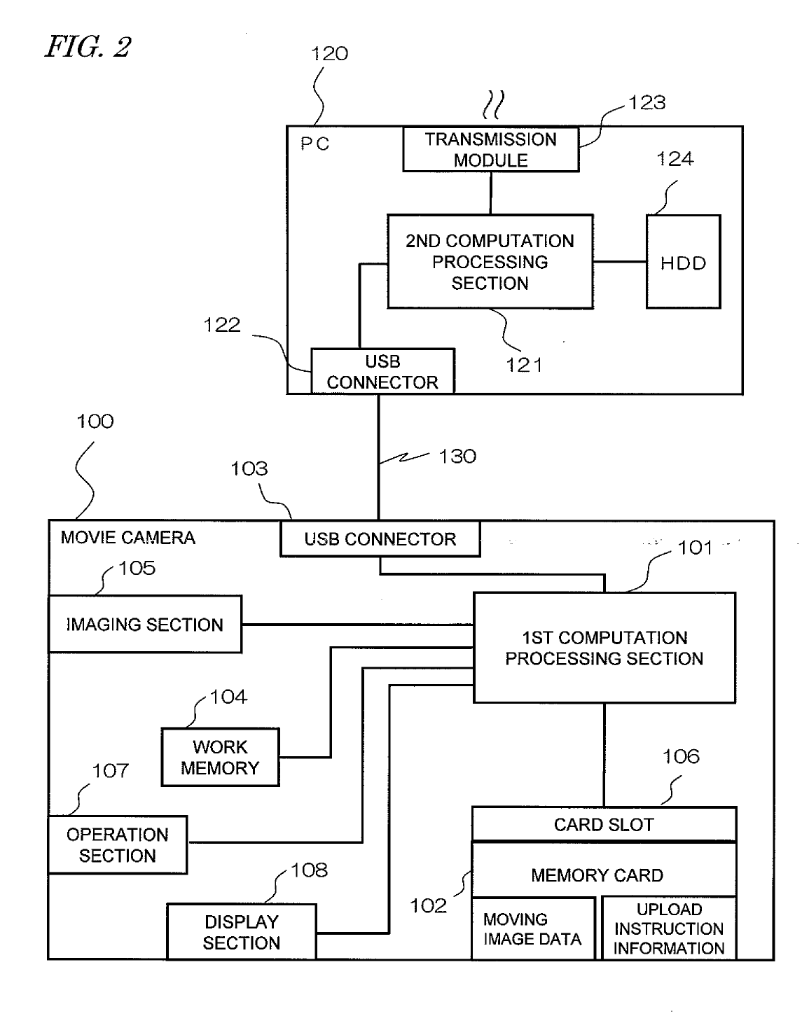

FIG. 2 is a block diagram showing an overall structure of an information recording system according to Embodiment 1 of the present invention. The information recording system in this embodiment includes a movie camera 100 and a personal computer (PC) 120. In this embodiment, data on a moving image or a still image obtained by the movie camera 100 can be uploaded to a web server on the Internet via the PC 120. Hereinafter, a case where moving image data is uploaded will be described as an example, but the data to be uploaded may be still image data or any other type of data.

The movie camera 100 in this embodiment includes a card slot 106 to which a memory card 102 is attachable. The memory card 102 can be attached to the card slot 106. Moving image data is recorded on the memory card 120. When a user operates the movie camera 100 to select data that he/she wishes to upload to the web server on the Internet, among moving image data and still image data which have been recorded, the information on the selected data is recorded on the memory card 102 as upload instruction information.

After this, when the user connects the movie camera 100 and the PC 120 to each other via a USB cable 130, the PC 120 reads the upload instruction information from the memory card 102, and uploads the moving image data from the memory card 102 to the web server on the Internet via a transmission module 123. When the upload is completed, the PC 120 notifies the movie camera 100 that the upload has been completed via the USB connector 122 as upload completion information. Upon receipt of the notice that the upload has been completed, the movie camera 100 temporarily records the upload completion information on a work memory 104. After this, when the connection by the USB cable 130 is disconnected, the movie camera 100 changes the upload instruction information in the memory card 102 in accordance with the upload completion information temporarily stored.

Hereinafter, with reference to the figures, a system configuration and an operation of the movie camera 100 will be described in detail.

### [1. System Configuration]

First, a system configuration of the movie camera 100 and the PC 120 will be described with reference to FIG. FIG. 2 shows an overall configuration of the information recording system including the movie camera 100 and the PC 120.

The movie camera 100 includes a first computation processing section 101 for controlling an overall operation of the movie camera 100, the card slot 106, a USB connector 103, the work memory 104, an imaging section 105, an operation section 107, and a display section 108.

The imaging section 105 includes an optical system and an image sensor although these elements are not shown. The optical system may include a plurality of lenses including a zoom lens and a focusing lens. The image sensor includes a plurality of photosensing cells (photodiodes) located on an imaging area, and outputs an electrical signal in accordance with an image of a subject by means of photoelectric conversion. A typical example of the image sensor is a CCD or a CMOS sensor. The imaging section 105 may include an image processing section for performing various types of processing such as color tone correction, image size change or the like. The imaging section 105 outputs an image signal acquired by shooting.

The first computation processing section 101 is a processing section for executing processing on the movie camera 100. The first computation processing section 101 is typically a CPU, and controls an overall operation of the movie camera 100 in accordance with a control program. The first computation processing section 101 is electrically connected to the imaging section 105, the card slot 106, the USB connector 103, the work memory 104, the operation section 107, and the display section 108. The first computation processing section 101 performs image processing and digital encoding processing on a video obtained by the imaging section 105 and records the resultant data on the memory card 102 as moving image data. The first computation processing section 101 also performs processing on a request for direct access to the information in the memory card 102 and upload completion information, which are transmitted from the PC 120 via the USB connector 103.

The USB connector 103 is a connector of the USB (Universal Serial Bus) standard. To the USB connector 103, the PC 120 is connected via the USB cable 130. This allows the movie camera 100 to transmit data to, and receive data from, the PC 120.

The memory card 102 is a storage medium capable of storing information such as moving image data. The PC 120 connected to the USB connector 103 can directly read information recorded on the memory card 102 but cannot directly write information on the memory card 102. In general, exactly the same image cannot be obtained twice. Therefore, moving image data which has been obtained is often highly important to the user. For this reason, write on the memory card 102 by the PC 120 is prohibited so that the moving image data recorded on the memory card 102 is not inadvertently deleted or falsified. By contrast, data such as upload instruction information or the like is of a low level of importance because exactly the same data can be reproduced by the user making the same operation. Thus, it is not highly required to prohibit write by the PC 120 from the point of view of such data. However, in the case where such information of different levels of importance is recorded on the same memory card 102, writing of data by the PC 120 is prohibited in order to protect important information such as moving image data. Therefore, the PC 120 cannot write even information of a relatively low level of importance, such as upload instruction information.”

Thus, information that is not so important cannot be written by the PC 120, which is inconvenient. A method for solving this problem will be described later in detail.

The work memory 104 is a storage medium for storing information required for internal processing of the movie camera 100. The work memory 104 is a semiconductor memory such as, for example, a DRAM or a ferroelectric memory. The work memory 104 acts as a work space for computation processing executed by the first computation processing section 101. The PC 120 connected to the USB connector 103 is structured not to directly write information to, directly read information from, the work memory 104.

The display section 108 is a device for displaying an obtained image or an image recorded on the memory card 102. The display section 108 may include, for example, a liquid crystal display or an organic EL display.

The operation section 107 includes a plurality of buttons or levers for receiving an operation by the user. The operation section 107 may include a touch panel provided on the display section 108. Owing to such a structure of the operation section 107, the user can make an instruction on start or finish of shooting, browse the recorded images, and make an upload instruction described later.

The movie camera 100 in this embodiment may include known elements such as a power source (battery), an inclination sensor, a flashlight or the like, but these elements are not specifically important for understanding of this embodiment and will not be described.

In this embodiment, in the state where the movie camera 100 and the PC 120 are connected to each other via the USB cable 130, the first computation processing section 101 can read information from, and also write information to, the memory card 102. By contrast, the PC 120 can only read information from the memory card 102 but cannot write information thereto.

Now, a structure of the PC 120 will be described.

The PC 120 includes a second computation processing section 121, a USB connector 122, the transmission module 123, and a HDD (hard disc drive) 124.

The second computation processing section 121 is a processing section for executing processing on the PC 120. The second computation processing section 121 is electrically connected to the USB connector 122, the transmission module 123, and the HDD 124. The second computation processing section 121 can read information from the memory card 102, or transmit upload completion information to the movie camera 100, via the USB connector 122. The, second computation processing section 121 transmits information (moving image data, etc.) to a website via the transmission module 123.

The USB connector 122 is a connector of the USB standard. To the USB connector 122, the movie camera 100 is connected via the USB cable.

The transmission module 123 is a module for transmitting information to, and receiving information from, a website on the Internet. The transmission module 123 uploads moving image data or the like to the website in accordance with an instruction from the second computation processing section 121. As the transmission module 123, any device having a communication function is usable regardless of whether such a device operates in a wired manner or in a wireless manner.

The HDD 124 is a drive for reading information from a hard disc (HD), which is a storage medium for storing information. The HDD 124 can record the information, read by the second computation processing section 121 from the memory card 102, on a hard disc built therein as it is or after performing processing on such information.

The PC 120 may include known elements such as an optical disc drive, a memory, an input interface or the like in addition to the elements shown in FIG. 2, but such additional elements are not specifically important for understanding of this embodiment and will not be described.

[2. Correspondence with the Present Invention]

The first computation processing section 101 is an example of the control section according to the present invention. Namely, the first computation processing section 101 has a function of the control section according to the present invention. The work memory 104 is an example of the first storage medium according to the present invention. The memory card 102 is an example of the second storage medium according to the present invention. The movie camera 100 is an example of the recording control device according to the present invention. The PC 120 is an example of the external information device according to the present invention. The second computation processing section 121 is an example of the processor according to the present invention.

### [3. Operation of the System]

Now, processing which is executed in accordance with an operation made by the user will be described.

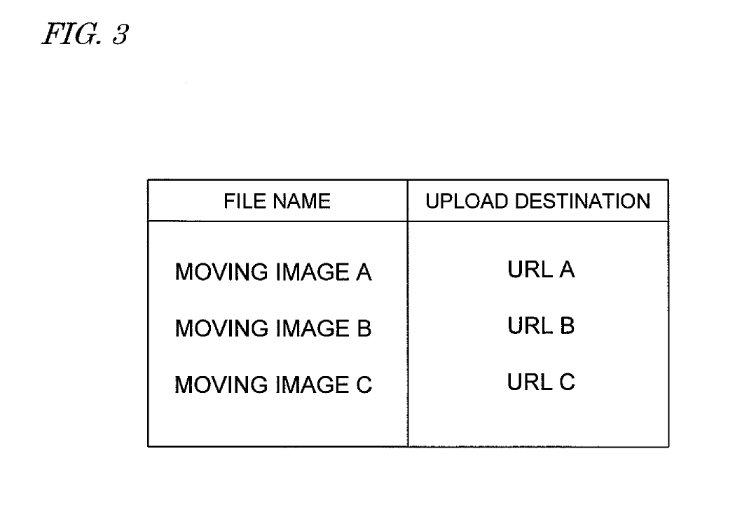

On the memory card 102 in the movie camera 100, moving image data obtained by the user in advance is recorded. As well as the moving image data, other data such as still image data or the like may be recorded. As described above, the movie camera 100 includes the display section 108 for displaying a list of moving image data stored on the memory card 102 and the operation section 107 for allowing the user to select data that he/she wishes to upload to the website, among the moving image data displayed on the display section 108. The “operation section 107” is a general term for a touch panel located in the display section 108, a hard key located on an external surface of the movie camera 100 and the like. The user checks the moving image data displayed on the display section 108 and uses the operation section 107 to select moving image data as a target of upload. The first computation processing section 101 records information on the selected moving image data on the memory card 102 as upload instruction information. As shown in FIG. 3, the upload instruction information includes file names of the moving image data selected by the user and upload destinations of such moving image data (websites corresponding to the servers to which the moving image data is to be uploaded), which are paired for management. In the example shown in FIG. 3, the upload destinations are designated by URLs (Uniform Resource Locators), but the upload instruction information may be represented in any form. By referring to the upload instruction information read from the movie camera 100, the PC 120 can determine which moving image data is to be uploaded to the server of which website and thus can perform transmission processing.

Now, processing which is executed when the user connects the movie camera 100 and the PC 120 to each other by use of a USB cable will be described. When the movie camera 100 and the PC 120 are connected to each other by use of the USB cable, connection is automatically established in accordance with a USB connection protocol, and thus the movie camera 100 and the PC 120 are put into a communicable state. After this, until the connection is disconnected, the PC 120 can read information recorded on the storage medium 102 in the movie camera 100. As described above, however, the PC 120 cannot record information on the storage medium 102 while the communication is maintained.

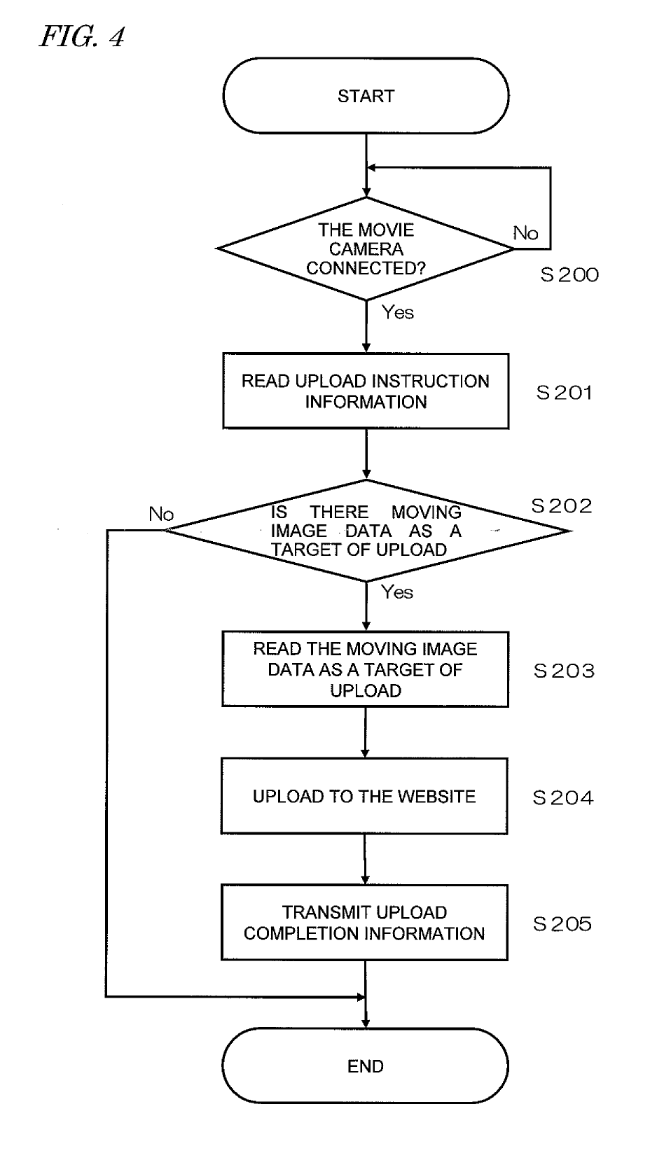

When the user connects the movie camera 100 and the PC 120 to each other via the USB cable, an operation shown in FIG. 4 is executed. FIG. 4 is a flowchart showing a processing operation executed by the second computation processing section 121 in this case.

In step S200, the second computation processing section 121 first determines whether the movie camera 100 has been connected to the USB connector 122 or not. When determining that the USB connector 103 of the movie camera 100 and the USB connector 122 of the PC 120 have been connected to each other via a USB connection cable by the user, the second computation processing section 121 advances the operation to step S201. In step S201, the second computation processing section 121 reads the upload instruction information recorded on the memory card 102 in the movie camera 100 via the USE connector 122. Next, the second computation processing section 121 checks the contents of the upload instruction information and determines whether or not there is the moving image data as a target of upload (S202). When determining that there is the moving image data as a target of upload, the second computation processing section 121 refers to the upload instruction information to read the upload destination of the moving image data as a target of upload (S203). In the case where information on the moving image as a target of upload has been recorded, the second computation processing section 121 may read the moving image as a target of upload from the memory card 102 via the USB connector 122. By the operation performed so far, the second computation processing section 121 acquires the moving image data as a target of upload and the information on the upload destination. The second computation processing section 121 uploads the moving image data as a target of upload to the website on the Internet via the transmission module 123 (S204). The upload may be automatically executed by the second computation processing section 121 in accordance with a control program or may be executed in accordance with an instruction from the user.

When the upload is completed, the second computation processing section 121 transmits upload completion information which indicates that the upload has been completed to the movie camera 100 via the USB connector 122 (S205). Whether the upload has been completed or not may be determined by the second computation processing section 121 itself when finishing uploading the moving image data as a target of upload to the upload destination, or may be determined by acquisition by the second computation processing section 121 of information indicating that the upload has been completed from the server of the website as the upload destination.

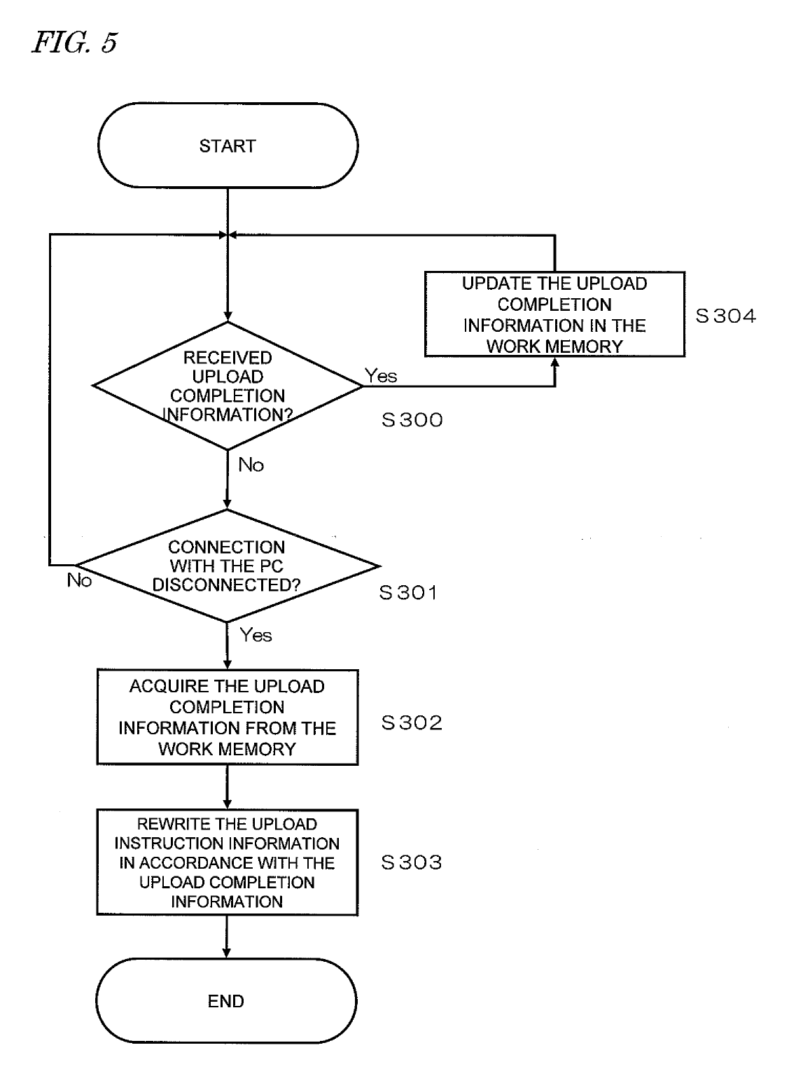

Now, a processing operation executed when the movie camera 100 receives the upload completion information transmitted from the PC 120 will be described with reference to FIG. 5.

The first computation processing section 101 in the movie camera 100 determines whether the upload completion information has been received from the PC 120 via the USB connector 103 or not (S300). When the upload completion information has been received, the first computation processing section 101 temporarily records (updates) the upload completion information received from the PC 120 on the work memory 104 (S304).

The first computation processing section 101 senses whether the connection by the USB cable has been disconnected or not (S301). As long as the connection by the USB cable is maintained, the first computation processing section 101 repeats the operation of steps S300 and S304.

When the connection between the USB connector 103 and the USB connector 122 via the USB cable is disconnected (when the USB cable is pulled out), the first computation processing section 101 acquires the upload completion information temporarily recorded on the work memory 104 (S302). Next, the first computation processing section 101 updates the upload instruction information in the memory card 102 in accordance with the acquired upload completion information (S303). Namely, the first computation processing section 101 records upload instruction information, updated in accordance with the upload completion information temporarily recorded on the work memory 104, on the memory card 102.

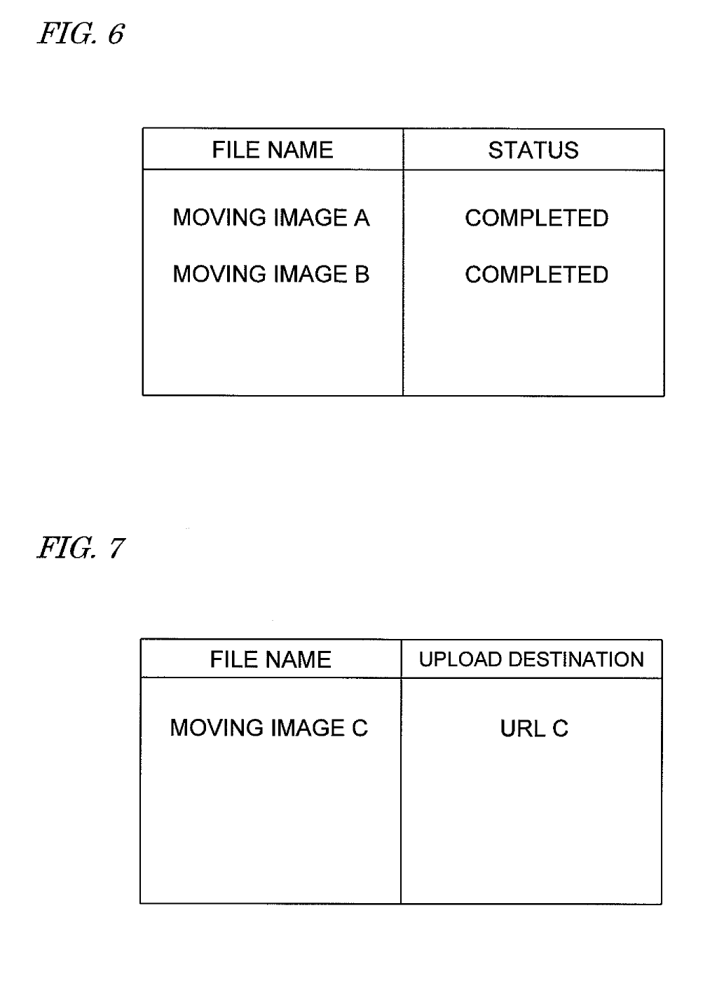

A specific example of operation in this case will be described. It is assumed that, for example, before the PC 120 makes the upload operation, the upload instruction information includes information which indicates that a moving image A, a moving image B and a moving image C are targets of upload as shown in FIG. 3 by the selection of the user. It is also assumed that after the PC 120 makes the upload operation, the upload completion information acquired by the movie camera 100 from the PC 120 includes information which indicates that the upload of the moving image A and the moving image B has been completed as shown in FIG. 6. This upload completion information is information already recorded on the work memory 104 before the connection between the movie camera 100 and the PC 120 via the USB cable was disconnected. Among the moving image A, the moving image B and the moving image C as targets of upload, the moving image A and the moving image B have been uploaded. Thus, as a result of the processing in step S303, the upload instruction information has only the information on the moving image C left. The first computation processing section 101 records upload instruction information, including only the moving image C as shown in FIG. 7, on the memory card 102 in accordance with the upload completion information temporarily recorded on the work memory 104.

As described above, the first computation processing section 101 in the movie camera 100 receives an upload completion notice from the PC 120 and changes the upload instruction information in accordance with the contents thereof. If the upload instruction information is set to be updatable while the movie camera 100 and the PC 120 are connected to each other via the USB cable, the PC 120 may possibly read the upload instruction information before the upload instruction information is updated. In this case, the upload instruction information cannot be changed. In the meantime, while the connection by the USB cable is disconnected (while the USB cable is pulled out), it is guaranteed that the information on the memory card 102 is not accessible from the PC 120. Hence, in this embodiment, after the received upload completion notice is temporarily recorded on the work memory 104, when the connection between the movie camera 100 and the PC 120 via the USB cable is disconnected, the upload instruction information is updated. Namely, the upload instruction information is changed at a timing when it is guaranteed that the PC 120 does not read the upload instruction information from the memory card 102.

As described above, the movie camera 100 according to this embodiment includes the USB connector 103 connectable to the PC 120 by use of a USB cable, the first computation processing section 101 for acquiring upload completion information from the PC 120 via the USB connector 103, and the work memory 104 for storing the acquired update completion information. When the USB connection is disconnected, the first computation processing section 101 records the upload instruction information, updated based on the upload completion information recorded on the work memory 104, on the memory card 102. While the movie camera 100 according to this embodiment is connected to the memory card 102 and the PC 120, the first computation processing section 101 can read information from, and also write information to, the memory card 102. However, the PC 120 can only read information from the memory card 102.

The movie camera 100 according to this embodiment operates as follows. While the movie camera 100 is connected to the PC 120 via a USB cable, recording on the memory card 102 by the PC 120 is restricted, in order to avoid the risk that information of a high level of importance (moving image data) recorded on the memory card 102 mounted on the movie camera 100 is deleted or falsified by the PC 120. Meanwhile, the first computation processing section 101 reads data which is desired to be recorded on the memory card 102, such as upload completion information, from the PC 120 while the movie camera 100 is connected to the PC 120 via a USB cable and temporarily records such data on the work memory 104. After the USB connection is disconnected, namely, when it is guaranteed that no read operation is made, the first computation processing section 101 records upload instruction information, updated in accordance with the upload completion information temporarily stored on the work memory 104, on the memory card 102. Owing to this, the first computation processing section 101 can certainly change, by use of the work memory 104, the upload instruction information, which is information of a low level of importance recorded on the memory card 102, in accordance with the upload completion information notified by the PC 120.

### [4. Other Embodiments]

The present invention is not limited to Embodiment 1 described above, and is applicable to other embodiments. Hereinafter, such other embodiments will be described.

### [4.1 Backup]

In Embodiment 1 described above, the PC 120 uploads moving image data or other types of data in the memory card 102 to a website. The present invention is not limited to such a form. For example, the present invention is applicable for storing moving image data on a hard disc as a backup by use of the HDD 124 in the PC 120. In this case, the user selects the moving image data as a target of backup by use of the operation section 107 in the movie camera 100, and backup instruction information is recorded on the memory card 102. The second computation processing section 121 reads the moving image data as a target of processing from the memory card 102 in accordance with the backup instruction information, and records this moving image data on the hard disc. When the recording is completed, the second computation processing section 121 transmits backup completion information to the movie camera 100. Upon receipt of the backup completion information, the first computation processing section 101 stores the information on the work memory 104. After sensing that the connection between the movie camera 100 and the PC 120 has been disconnected, the first computation processing section 101 records backup instruction information, updated in accordance with the backup completion information temporarily stored on the work memory 104, on the memory card 102. Owing to this, information on the backup instruction to the HDD 124 in the PC 120 can be recorded on the memory card 102 in the movie camera 100 with certainty.

The operation of the second computation processing section 121 for the backup processing in this embodiment is substantially the same as the operation shown in FIG. 4, and the operation of the first computation processing section 101 for the backup processing in this embodiment is substantially the same as the operation shown in FIG. 5. The PC 120 may be structured to perform both of the backup processing in this embodiment and the upload processing in Embodiment 1.

### [4.2 Recording the Upload Completion Information on the Memory Card 102]

In the above-described embodiment, the first computation processing section 101 temporarily records the upload completion information acquired from the PC 120 on the work memory 104. After the USB connection is disconnected, the movie camera 100 records the upload instruction information, updated in accordance with the upload completion information temporarily recorded on the work memory 104, on the memory 102. The present invention is not limited to such a form. After the USB connection is disconnected, the movie camera 100 may record the upload completion information itself, temporarily stored on the work memory 104, on the memory card 102. Owing to this, the movie camera 100 can grasp the moving image data uploaded in the past by referring to the upload completion information recorded on the memory card 102. In this case also, it is preferable that while the USB connection is maintained, recording on the memory card 102 by the PC 120 is restricted, in order to avoid the risk that information of a high level of importance (moving image data, etc.) recorded on the memory card 102 mounted on the movie camera 100 is deleted or falsified by the PC 120. After the USB connection is disconnected, namely, when it is guaranteed that no information read is made by the PCT 120, recording on the memory card is performed. Therefore, while the risk that data recorded on the memory card 102 is inadvertently deleted or falsified by the PC 120 is avoided, necessary information can be recorded on the memory card 102 with certainty.

### [4.3 Acquiring Upload Non-Completion Information]

In Embodiment 1 described above, the movie camera 100 is structured to acquire the upload completion information from the PC 120. The present invention is not limited to such a form. For example, the movie camera 100 may acquire “upload non-completion information”, which represents data of which the upload or backup has not been completed, from the PC 120. In this case, the movie camera 100 temporarily records the acquired upload non-completion information on the work memory 104. After the USB connection is disconnected, the movie camera 100 records the upload non-completion information temporarily recorded on the work memory 104, or new upload completion information updated based on the upload non-completion information, on the memory card 102. In this case also, it is preferable that while the USB connection is maintained, recording on the memory card 102 by the PC 120 is restricted, in order to avoid the risk that information of a high level of importance (moving image data, etc.) recorded on the memory card 102 mounted on the movie camera 100 is deleted or falsified by the PC 120. After the USB connection is disconnected, namely, when it is guaranteed that no information read is made by the PCT 120, recording on the memory card is performed. Therefore, while the risk that data recorded on the memory card 102 is inadvertently deleted or falsified by the PC 120 is avoided, necessary information can be recorded on the memory card 102 with certainty.

In the case where backup is performed instead of upload, the PC 120 may be structured to transmit backup non-completion information to the movie camera 100 instead of the backup completion information in a similar manner to described above. In such a structure also, the above-described structure and operation are applicable in the same manner.

Alternatively, information representing the data of which the upload or backup has been completed and the state of the data of which the upload or backup has not been completed may be used. Even when such information is used, the movie camera 100 can grasp data on which the processing has been completed, and therefore substantially the same effect can be provided.

### [4.4 Recording Other Types of Data]

The data to be recorded on the memory card 102 is not limited to moving image data, and may be still image data, audio data, or any other type of data. The PC 120 can transmit any type of data such as the moving image data, still image data, audio data or the like, which is desired to be recorded on the memory card 102 mounted on the movie camera 100, to the movie camera 100. The movie camera 100 temporarily records such data acquired from the PC 120 on the work memory 104. The movie camera 100 may be structured to record the data, temporarily recorded on the work memory 104, on the memory card 102 after the USB connection is disconnected. In this case also, it is preferable that while the USB connection is maintained, recording on the memory card 102 by the PC 120 is restricted, in order to avoid the risk that information of a high level of importance (moving image data, etc.) recorded on the memory card 102 mounted on the movie camera 100 is deleted or falsified by the PC 120. After the USB connection is disconnected, namely, when it is guaranteed that no information read is made by the PCT 120, recording on the memory card is performed. Therefore, while the risk that data recorded on the memory card 102 is inadvertently deleted or falsified by the PC 120 is avoided, moving image data, still image data, audio data or any other type of data as a target of recording requested by the PC 120 can be recorded on the memory card 102 with certainty.

In this embodiment, the data transmitted by the PC 120 to the movie camera 100 is not a response to the data transmitted from the movie camera 100, but is merely data which is desired to be recorded on the memory card 102. Therefore, instruction information such as upload instruction information or backup instruction information does not need to be recorded on the memory card 102.

### [4.5 Storage Mediums Other Than the Memory Card]

In Embodiment 1 described above, the memory card 102 is used as the storage medium for storing data, but the storage medium is not limited to the memory card 102, which is detachable from the movie camera 100. Any type of storage medium such as a memory built in the movie camera 100, a hard disc, an optical disc or the like may be used.

### [4.6 Connection Methods Other Than USB Connection]

In Embodiment 1 described above, the movie camera 100 and the PC 120 are connected to each other by USB connection. The connection method may be of any type, as long as information can be transmitted and received between the movie camera 100 and the PC 120 and it can be confirmed whether there is connection or not; for example, IEEE1394, wired LAN, or wireless LAN. In addition, the above-described recording control may be performed based on whether there is physical connection or not, or alternatively, based on whether there is logical connection or not. An example of logical connection is a session in the TCP (Transmission Control Protocol) communication. In the case where the TCP communication is made, the first computation processing section 101 can record the information recorded on a memory or other information based on such information on a storage medium in synchronization with the timing when the TCP session is disconnected.

### [4.7 Devices Other Than the Movie Camera and PC]

In Embodiment 1 described above, it is assumed that the movie camera 100 is used as an example of the recording control device and the PC 120 is used as an example of the information device. The present invention is not limited to such a structure. Instead of the movie camera 100, any electronic device including a processor can execute a program defining each of the above-described types of processing. In this case also, substantially the same functions can be realized. Other examples of the recording control device include devices such as a digital still camera, a media recorder and a mobile information terminal.

Instead of the PC 120, any electronic device including a processor can execute a program defining each of the above-described types of processing. In this case also, substantially the same functions can be realized. Examples of devices usable instead of the PC 120 include a mobile information terminal, a work station and the like.

The program executed by the recording control device and the information device may be recorded on any type of storage medium such as a CD-ROM, a DVD-ROM or the like and distributed via an electrical communication line. In the case where, for example, such a program is executed by a server located in a data center or the like, services can be provided to a remote user in the form of the so-called cloud computing.

The present invention is applicable to any type of recording control device which can acquire information from another device; namely, the present invention is applicable to, for example, a still camera, a media recorder or the like, as well as a movie camera.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2011-089886 filed Apr. 14, 2011 and No. 2012-085480 filed Apr. 4, 2012, the entire contents of which are hereby incorporated by reference.

What is claimed is:

1. A recording control device connectable with an external information device and capable of transmitting and receiving information via the connection, the recording control device comprising:
a first storage medium; and
a control section configured to, when acquiring the information from the external information device, store the information on the first storage medium, and when the connection with the external information device is disconnected, record the information stored on the first storage medium, or other information based on the information stored on the first storage medium, on a second storage medium.

2. The recording control device of claim 1, further comprising a connector for connecting the recording control device to the external information device via a cable;
wherein when the cable is pulled out after the control section stores the information on the first storage medium, the control section records the information stored on the first storage medium, or other information based on the information stored on the first storage medium, on the second storage medium.

3. The recording control device of claim 1, wherein the control section, after transmitting data to the external information device, acquires a notice regarding processing of the data from the external information device as the information.

4. The recording control device of claim 3, wherein
the external information device, when acquiring the data from the control section, uploads the data to another device via a network, and
the control section acquires a notice regarding the upload of the data from the external information device as the information.

5. The recording control device of claim 3, wherein
the external information device, when acquiring the data from the recording control device, stores the data on the second storage medium as a backup, and
the control section acquires a notice regarding the backup of the data from the external information device as the information.

6. The recording control device of claim 3, wherein the control section transmits the data to the external information device based on instruction information recorded on the second storage medium, and when receiving a notice indicating whether the processing of the data has been completed or not from the external information device, updates the instruction information.

7. The recording control device of claim 6, wherein the instruction information is information indicating data that is set by a user as a target of transmission.

8. The recording control device of claim 3, wherein the data includes data on a moving image.

9. The recording control device of claim 8, further comprising an imaging section for acquiring the moving image by shooting.

10. An information device configured to process data transmitted from the recording control device of claim 1, the information device comprising a processor configured to execute the steps of:
sensing that connection with the recording control section has been established;
reading instruction information that defines data to be processed from the second storage medium when the connection is established;
processing the data based on the instruction information if there is the instruction information; and
transmitting information indicating whether the processing of the data has been completed or not to the information device.

11. An information recording system, comprising:
an information device; and
a recording control device connectable with the information device and capable of transmitting and receiving information via the connection, the recording control device including:
a first storage medium; and
a control section configured to, when acquiring the information from the external information device, store the information on the first storage medium, and when the connection with the external information device is disconnected, record the information stored on the first storage medium, or other information based on the information stored on the first storage medium, on a second storage medium.

12. A computer program, stored on a non-transitory computer-readable medium, to be executed by a computer mounted in a recording control device connectable with an external information device and capable of transmitting and receiving information via the connection, the program causing the computer to execute:
acquiring information from the external information device;
storing the information on a first storage medium; and
sensing that the connection with the external information device has been disconnected and recording the information stored on the first storage medium, or other information based on the information stored on the first storage medium, on a second storage medium.

13. A computer program, stored on a non-transitory computer-readable medium, to be executed by a computer mounted in an information device configured to process data transmitted from the recording control device of claim 1, the program causing the computer to execute:
sensing that connection with the recording control device has been established;
reading instruction information which defines data to be processed from the second storage medium when the connection is established;
processing the data based on the instruction information if there is the instruction information; and
transmitting information indicating whether the processing of the data has been completed or not to the information device.
